(19) United States
(12) Patent Application Publication
(10) Pub. No.: US 2014/0058700 A1
(43) Pub. Date: Feb. 27, 2014

(54) METHOD AND DEVICE FOR TESTING THE PROPER WORKING ORDER OF AN ELEVATOR

(71) Applicant: Matthias Gehrke, Nuernberg (DE)

(72) Inventor: Matthias Gehrke, Nuernberg (DE)

(21) Appl. No.: 14/000,294

(22) PCT Filed: Feb. 28, 2012
(86) PCT No.: PCT/EP12/53353

§ 371 Date: Sep. 18, 2013

(30) Foreign Application Priority Data
Mar. 7, 2011 (DE) 10 2011 005 205.4
May 20, 2011 (DE) 10 2011 076 241.8

(51) Int. Cl. B66B 5/00

(52) U.S. Cl. CPC B66B 5/0018
USPC 702/141

(57) ABSTRACT

This invention relates to a method for testing the proper working order of an elevator, having the following steps: providing an acceleration measuring device (5) of an elevator car (3) that can be moved in a z direction, an acceleration of the car (3) in the z direction being measurable dependent on time using the acceleration measuring device (5); providing an optical distance measuring device (7) for measuring a distance of the car (3) or of the counterweight (4) relative to a fixed point dependent on time; simultaneously detecting first values that are measured using the acceleration measuring device (5) and second values that are measured using the distance measuring device (7); and producing a travel curve (Ak, Bk) that reproduces the movement of the car (3) using the first and second values.

The invention relates to a method and device for testing the proper working order of an elevator.

DE 10 2009 026 992 AI discloses a method for testing the proper working order of an elevator. For testing drivability of a traction sheave, an elevator car is here moved upwards while a braking device is triggered. At the same time, a distance of the elevator car from a fixed measurement point is measured dependent on time using an optical distance sensor. From the values measured using the latter, the drivability of the traction sheave is then ascertained.

DE 10 2006 042 909 A1 discloses a further method for determining the drivability of a traction sheave. To ascertain the drivability, a brake acceleration occurring during deceleration of the elevator car during upward travel is ascertained. To do so, sensors for recording the brake acceleration are attached to the elevator car and to the traction sheave. The measured values obtained thereby and reproducing the brake acceleration are used directly for ascertaining the drivability. No exact travel curve of the elevator car can be generated from the measured values of the brake acceleration.

G 89 04 375 U1 discloses a device for recording physical parameters in an elevator. Here a travel sensor is provided on a traction sheave and connected to an evaluation unit. The travel sensor has a perforated disk and at least one light barrier scanning the perforated disk. Furthermore, a force measurement signal transmitter is provided using which the forces transmitted by a cable winch and determining the movement sequence of the elevator car can be determined. In particular, the drivability of the traction sheave can be ascertained by means of the force measurement signal transmitter. The proposed device is an integral part of the elevator. Its manufacture is costly. It is not suitable for testing the proper working order of an elevator by an independent testing company.

The object of the invention is to eliminate the drawbacks according to the prior art. In particular, a method is to be indicated that permits testing of the proper working order of an elevator at the lowest possible expense. According to a further object of the invention, a simplest possible and inexpensively designed device for implementing the method is to be indicated.

This object is achieved by the features of Claims 1, 12 and 18. Expedient embodiments of the invention result from the features of Claims 2 to 11 and 13 to 17.

According to the invention, a method with the following steps is proposed for testing the proper working order of an elevator:

provision of an acceleration measuring device on an elevator car movable in a z direction, where an acceleration of the elevator car in the z direction can be measured dependent on time using said acceleration measuring device,

provision of an optical distance measuring device for measuring of a distance of the elevator car or of the counterweight relative to a fixed point dependent on time,

simultaneous recording of first values measured using the acceleration measuring device and of second values measured using the first distance measuring device, and

producing of a travel curve reproducing the movement of the elevator car using the first and second values.

In the meaning of the present invention, the term “z direction” is generally understood as the movement direction of the elevator car. An x and a y direction span a plane running vertically to the z direction.

A “fixed point” is understood as a point inside an elevator shaft of the elevator. This is expediently a shaft bottom of the elevator shaft. A transmitting/receiving unit of the optical distance measuring device can for example be positioned on the shaft bottom. With the distance measuring device, it is possible to measure quickly and accurately a distance of the elevator car or counterweight relative to the fixed point over time.

The combination proposed in accordance with the invention, of measurement of the distance of the elevator car or counter-weight over time using an optical distance measuring device and of the acceleration of the elevator car, permits the production of exact travel curves in a simple, rapid and inexpensive way. From these, all the essential key quantities necessary for testing the proper working order of an elevator can be ascertained. The production of the travel curve and/or the determination of appropriate parameters is best achieved using predetermined algorithms by means of a computer.

According to an advantageous embodiment of the invention, the distance measuring device used is of the laser type. With a laser distance measuring device of this type, it is possible with a high time resolution to measure the distance of the elevator car or of the counterweight relative to a fixed point, for example by a running time measurement from the phase difference. A suitable laser distance measuring device is described in more detail in DE 10 2009 026 992 AI as mentioned at the outset, of which the disclosure content relating to the description of the laser distance measuring device is herewith incorporated.

With the acceleration measuring device, an acceleration in the x, y and z directions can be advantageously measured dependent on time. The acceleration measuring device can here also be attached to an elevator car door of the elevator car. This also enables precise recording of the movements of the elevator car door dependent on the travel of the elevator car in the z direction.

According to a further advantageous embodiment, the measured first values are saved as a data record using the acceleration measuring device. The saved data record is expediently transmitted to an evaluation unit via an interface provided on the acceleration measuring device. This means that the proposed acceleration measuring device is advantageously a self-contained unit which can comprise acceleration sensors, a processor, a real-time clock, a memory, an interface and a battery. The data records recorded therewith can, after completion of a predetermined movement sequence of the elevator car, be transmitted to the evaluation unit, for example a computer, and further processed there using a suitable program.

For implementation of the method in accordance with the invention, use can be made of conventionally available acceleration measuring devices. One example is the product “USB Accelerometer Model X6-2” from the company Gulf Coast Data Concepts, LLC, Waveland, Miss. 3957 6, USA.

Thanks to the combination proposed in accordance with the invention of distance measurement and acceleration measurement, the first values can be corrected using the second values by using a particularly advantageous embodiment. For correction of the first values, in particular of the first values relating to the acceleration in the z direction, at least one integration constant is calculated from the second values in accordance with an advantageous embodiment. This allows the avoidance of errors caused by an integration constant which is imprecise or which changes during the course of measurement of the first values. In consequence, it is possible using the proposed method to specify a particularly exact travel curve which can also contain information about the speed and/or acceleration development.

Before the correction, it is expedient to synchronize the first and the second values. Synchronization of this type is possible with particular ease when the values are registered dependent on real time.

It is expedient to produce a travel/time and/or a speed/time and/or a travel/acceleration diagram as the travel curve. This can also output movements of the elevator car or of the elevator car door in the x and/or y direction over travel or over time. It has proven particularly expedient to indicate in the travel/acceleration diagram an acceleration of the elevator car or the elevator car door in the x/y direction over travel. This enables an acceleration of the elevator car or elevator car door in the x/y direction dependent on travel to be detected quickly and easily.

From a comparison of the corrected first values and second values, cable slippage of a suspension cable over a suspension sheave can also be determined. This permits in a simple and inexpensive manner determination of the drivability and/or of a wear state of the traction sheave to be ascertained.

With the method proposed, it is therefore possible to detect and localize any faults in the operating sequence of an elevator in a simple, fast and inexpensive way. It is furthermore possible to determine where and at which speed and/or acceleration any disruptions or divergences from a predetermined movement sequence occur. That permits fast, simple and inexpensive diagnosis of the movement sequence or of faults during operation of an elevator.

In further accordance with the invention, a device for testing the proper working order of an elevator is proposed, comprising:

an acceleration measuring device using which an acceleration of the elevator car can be measured dependent on time and with which the first values measured therewith can be saved,

an optical distance measuring device, using which a distance of an elevator car or of a counterweight relative to a fixed point can be measured dependent on time and with which the second values measured therewith can be saved, and

an evaluation unit with a program for evaluation of the first and second values transmitted by the acceleration measuring device and by the distance measuring device in accordance with the inventive method.

The proposed device can be manufactured simply and inexpensively. A suitable distance measuring device and an acceleration measuring device are conventionally available. The evaluation unit can for example be a relatively inexpensively obtainable laptop.

According to an advantageous embodiment of the invention, the optical distance measuring device is a laser distance measuring device. In a laser distance measuring device of this type, for example, a transmitted light beam is modulated with a predetermined frequency. The transmitted light beam can be reflected by a reflector attached to the elevator car onto a receiver. The light propagation time can be determined there from the phase shift between the transmitted light beam and the received light beam, and from this a distance between the distance measuring device preferably forming the fixed point and the elevator car can in turn be determined.

In accordance with a further and particularly advantageous embodiment, the acceleration measuring device is provided with a fastening device, preferably a magnet. This permits simple attachment of the acceleration measuring device to the elevator car, to an elevator car door or also to the counterweight.

According to a further embodiment of the invention, the acceleration measuring device includes a battery for power supply. Expediently, the acceleration measuring device is mains-independent. It can be designed as a handy and mobile module which can be attached quickly and easily using a magnet, for example to the elevator car.

The acceleration measuring device can furthermore be provided with a USE, IR or Bluetooth interface. This permits quick and easy transmission of values measured using the acceleration measuring device or data records to the evaluation unit.

With the acceleration measuring device, accelerations in the x, y and z directions can be conveniently measured. This also permits in particular detection of accelerations in the elevator car or in a door of the elevator car in the x/y plane dependent on travel and/or time.

In further accordance with the invention, an elevator is proposed with a device in accordance with the invention, where the acceleration measuring device is attached to the elevator car, in particular to a door of the elevator car. When the acceleration measuring device is attached to the elevator car door, it is possible to precisely record the movements of the elevator car door dependent on the position of the elevator car in the z direction. The device in accordance with the invention can therefore be used both for detection of faults during operation of an elevator and as a development aid means for the development of new elevators.

In the following, a design example of the invention is explained in greater detail on the basis of the drawings. The drawings show, in

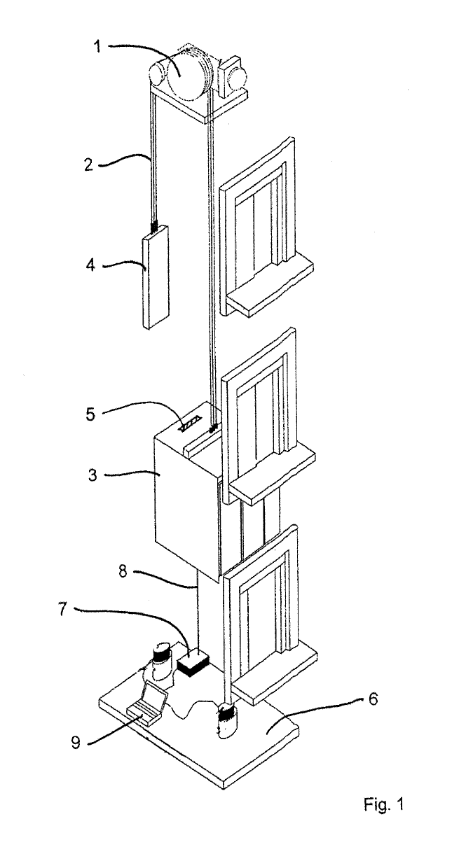

FIG. 1 a schematic view of an elevator,

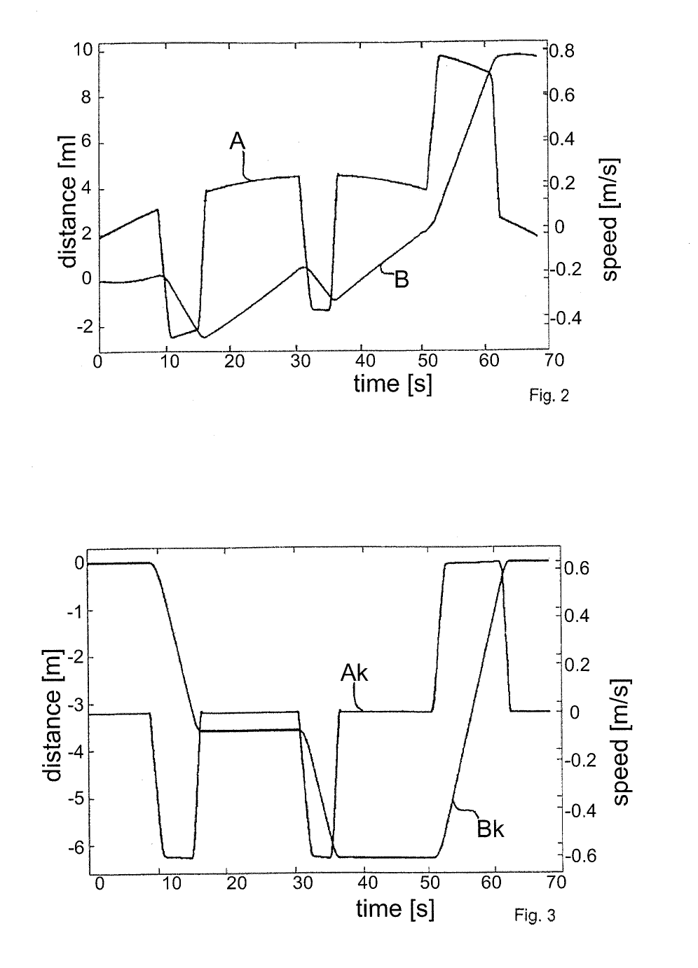

FIG. 2 a first travel curve and

FIG. 3 a second travel curve.

In the elevator shown in FIG. 1, a suspension cable 2 is passed over a traction sheave 1, to one end of which suspension cable an elevator car 3 and to its other end a counterweight 4 are attached. The reference number 5 designates an acceleration measuring device, for example designed in the manner of a “USB stick”, which is fastened, for example by means of a magnet, to a ceiling of the elevator car 3.

A laser distance measuring device 7, whose transmitted/received light beams are indicated with the reference number 8, is supported on a shaft bottom 6 of an elevator shaft, not shown in detail here. The laser distance measuring device 7 is connected to an evaluation unit 9, in this embodiment a laptop.

The acceleration measuring device 5 is for example a conventional and self-contained acceleration measuring device 5 or a so-called data logger using which accelerations in the x, y and z directions can be measured over time. An acceleration measuring device 5 of this type comprises acceleration sensors, a real-time clock, a processor, a current source, a memory unit and an interface for transmission of a data record. Instead of the interface, a memory card can also be provided on which the data record is recorded. After completion of a measuring sequence, the memory card can be removed and connected to the evaluation unit for data transfer.

For testing the proper working order of an elevator, the procedure is as follows:

First the acceleration sensor is attached to the elevator car 3. Also, the distance measuring device 7 is expediently supported on the shaft bottom 6. Its transmitted/received light beams 8 are directed onto a reflector (not shown here) attacked to the bottom of the elevator car 3. The distance measuring device 7 supported on the shaft bottom 6 forms in this case a fixed point relative to which a distance of the elevator car 3 is measured over time.

In the following, certain movement sequences of the elevator car 3 are performed in accordance with a predetermined protocol. After completion of the movement sequences, the acceleration measuring device 5 is removed from the elevator car 3. The data records saved in them are transmitted to the evaluation unit 9.

FIG. 2 shows travel curves which have been produced in the conventional way exclusively on the basis of first values obtained using the acceleration measuring device 5. A first curve A reproduces a speed for the elevator car 3 derived from the first values over time. A second curve B reproduces the travel of the elevator car 3 over time determined from the curve A.

The first curve A is obtained by integration of the first values. It shows disadvantageously a drift relative to its zero position. The second curve B is obtained by double integration of the first values. Lacking precise knowledge of the integration constants and/or their change during measurement, the result for the second curve B in particular is one considerably falsified from that in reality.

In FIG. 3, a corrected first curve Ak reproduces a speed of the elevator car 3 over time, and a corrected second curve Bk the travel of the elevator car 3 over time. To produce the corrected first curve Ak, the basis was once again the first values measured using the acceleration measuring device 5. With the distance measuring device 7, second values were measured which reproduce the distance of the elevator car 3 relative to the distance measuring device 7 over time. On the basis of the second values, an integration constant was determined using which the first values were corrected. On the basis of the corrected first values, the corrected first curve Ak was produced. As can be seen from FIG. 3, the first curve Ak reproducing the speed over time no longer shows any drift relative to its zero position. In the proposed embodiment, a distance measuring device 7 can be used which measures the second values with a lower time resolution than the acceleration measuring device 5. A relatively inexpensively available laser distance measuring device can be used as the distance measuring device 7.

The corrected second curve Bk resulting from integration of the corrected first values reproduces the travel of the elevator car 3 over time. The corrected second curve Bk corresponds—as is quite clear from a comparison of FIG. 3 with FIG. 2—to the actual conditions. Every plateau in the corrected second curve Bk corresponds to a stop by the elevator car 3 at a storey. The plateaus are arranged symmetrically to one another in FIG. 3, corresponding to an upward and downward travel of the elevator car 3 with stops at predetermined storeys. The corrected first curve Ak correlates precisely with the corrected second curve Bk.

Although this is not shown in the figures, the corrected second curve Bk shown in FIG. 3 can in particular be additionally correlated with curves reproducing the movement of the elevator car 3 or of an elevator car door in the x and/or y direction. This enables for example determination of whether an elevator car door already opens before a predetermined storey is reached, and if so in which state the opening operation begins before the predetermined storey is reached.

### List of Reference Numbers

1 traction sheave
2 suspension cable
3 elevator car
4 counterweight
5 acceleration measuring device
6 shaft bottom
7 distance measuring device
8 transmitted/received light beam
9 evaluation unit
A first curve
B second curve
Ak corrected first curve
Bk corrected second curve

1-18. (canceled)

19. A method of testing the proper working order of an elevator system having as a first component an elevator car and as a second component a counterweight, the method comprising the steps of:
measuring the acceleration of said first component in a z-direction in which said first component moves, the acceleration being measured dependent on time;
optically measuring the distance of one of said components relative to a fixed point dependent on time;
simultaneously recording a set of first values measured during the measurement of the acceleration and a set of second values measured during the measurement of the distance;
correcting said first values using said second values; and
producing a travel curve which reproduces the moment of said one component using the corrected first and second values.

20. A method according to claim 19 wherein the distance is measured by laser.

21. A method according to claim 19 wherein an acceleration of one of said components is measured in at least one of said z direction and x and y directions where the x and y directions lie in a plane vertical to the z direction.

22. A method according to claim 19 wherein the elevator car has a door and the acceleration measurement is carried on from the elevator car door.

23. A method according to claim 19, further comprising saving the measured first values as a data record.

24. A method according to claim 23, further comprising evaluating the saved data record.

25. A method according to claim 24 wherein the evaluation is effected by an evaluation unit and the acceleration is effected by acceleration measuring means having an interface by way of which the measurement is transmitted to the evaluation unit.

26. A method according to claim 19, further comprising calculating at least one integration constant from said second values for correction of said first values.

27. A method according to claim 19, further comprising synchronizing said first and second values prior to the correcting.

28. A method according to claim 19, further comprising producing at least one of a travel/time diagram, speed/time diagram and travel/acceleration diagram to serve as said travel curve.

29. A method according to claim 28 wherein it is an acceleration of the elevator in an x or y direction which is reflected in said travel/acceleration diagram, the x and y direction spanning a plane that is vertical to said z direction.

30. A method according to claim 28 wherein the elevator car has a door and it is acceleration of the car door in an x or y direction which is reflected in said acceleration diagram, the x and y directions spanning a plane that is vertical to said z direction.

31. An apparatus for testing the proper working order of an elevator system having as a first component an elevator car and as a second component a counterweight, the apparatus comprising:
acceleration measuring means for measuring the acceleration of the first component dependent on time and for saving a set of first values;
optical distance measuring means for measuring the distance between one of said components and a fixed point dependent on time and for saving a set of second values; and
evaluation means for receiving said first and second values and having a program for evaluating said first and second values, said program correcting said first values using said second values to produce a travel curve which reproduces the movement of the elevator car by using the corrected first values and said second values.

32. An apparatus according to claim 31 wherein said optical distance measuring means comprise a laser distance measuring device.

33. An apparatus according to claim 31 wherein said acceleration measuring means comprise fastening means.

34. An apparatus according to claim 31 wherein said acceleration measuring means comprise a battery serving as a power supply.

35. An apparatus according to claim 34 wherein said battery is a rechargeable battery.

36. An apparatus according to claim 31 wherein at least one of said measuring means is provided with a USB or IR or Bluetooth interface.

37. An apparatus according to claim 31 wherein said acceleration measuring means is a means for measuring acceleration in a z-direction which is the direction of movement in which the elevator car moves or in an x or y directions where x and y directions lie in a plane vertical to the z-direction.

38. An apparatus according to claim 31 wherein said acceleration measuring means is attached to the elevator car.
